(19) United States
(12) Patent Application Publication
(10) Pub. No.: US 2012/0179640 A1
(43) Pub. Date: Jul. 12, 2012

(54) TASK RELIABILITY ANALYSIS METHOD AND APPARATUS

(76) Inventors: Lance SHERRY, Fairfax, VA (US); Maricel MEDINA, Issaquah, WA (US)

(21) Appl. No.: 13/253,092

(22) Filed: Oct. 5, 2011

Related U.S. Application Data
(60) Provisional application No. 61/431,887, filed on Jan. 12, 2011.

(51) Int. Cl. G06N 5/02

(52) U.S. Cl. 706/52

(57) ABSTRACT

The embodiment of the invention relates generally to the methods and systems to determine the reliability of human-computer interactions for achieving a mission task in an automated system using a Task Reliability Analysis Tool (TRAT). In some examples, the TRAT can capture the details of human computer interactions while performing operator actions, allocating time-on-action distribution and conducting task evaluations. The allocated time-on-action distribution to the operator actions and to each task can be used subsequently to predict time to complete a task, and likelihood of failure for an infrequently performed task.

### CROSS-REFERENCE TO RELATED APPLICATION

This application claims the benefit of U.S. Patent Application Ser. No. 61/431,887, filed on Jan. 12, 2011, entitled “Human-Computer Interaction Evaluation,” the disclosure of which is incorporated herein by reference as though set forth in full below in the entirety.

### BRIEF DESCRIPTION OF THE DRAWINGS

FIG. 1 depicts an example of one or more embodiments of the Task Reliability Analysis Tool (TRAT).

FIG. 2 illustrates an example of a user interface of the Multi-Function Control and Display Unit (MCDU), according to one embodiment.

FIG. 3 depicts a sample of mission tasks for a commercial airliner, according to one embodiment.

FIG. 4 illustrates a method employed by the operator automation server to evaluate and predict reliability of human computer interactions for achieving a mission task, according to one embodiment of the present invention.

FIG. 5 illustrates how an operator action list is generated by the operator automation server, according to one embodiment.

FIG. 6 illustrates the method that the operator automation server employs to conduct the sensitivity analysis, according to one embodiment.

FIG. 7 is an example of a description of a mission task, according to one embodiment.

FIG. 8 is an example on how operator actions may be categorized, according to one embodiment.

FIG. 9 illustrates the competing cues for a list of operator actions, according to one embodiment.

FIG. 10 depicts an example of a graphic user interface of the mission task analysis, according to one embodiment.

FIG. 11 illustrates the page hierarchy of the graphic user interface of the TRAT, according to one embodiment.

FIG. 12 illustrates an example of a graphic user interface for the mission task definition of the TRAT, according to one embodiment.

FIG. 13 illustrates an example of a graphic user interface for the operator action definition of the TRAT, according to one embodiment.

FIG. 14 illustrates an example of a graphic user interface for the mission task specification and analysis of the TRAT, according to one embodiment.

### DETAILED DESCRIPTION OF SEVERAL EMBODIMENTS OF THE INVENTION

Embodiments of the invention can be directed to methods and systems to determine the reliability of human-computer interactions for achieving a mission task in an automated system. Mission tasks are the explicit set of tasks required to conduct the mission. For example, to execute the commercial airline transportation gate-to-gate mission, hundreds of tasks can be completed by the flightcrew, with the assistance of the flightdeck automation. Because human automation interaction can be a cyclical process, the operator can respond to automation cues through the automation input devices, which results in changes in the automation and further response by the operator.

In another example, an embodiment of the invention can be used in the evaluation and prediction of mission tasks pertaining to the solar, hydroelectric, nuclear or thermal power plants. Alternatively, an embodiment of the invention can be used in the evaluation and improvement of the usability of the website and web navigation including ease-of-learning and ease-of-use in an agile software development environment. Furthermore, those skilled in the art will recognize many applications of the invention beyond those listed above, such as operating a medical device, using a document creation program, or using any device with an operating interface.

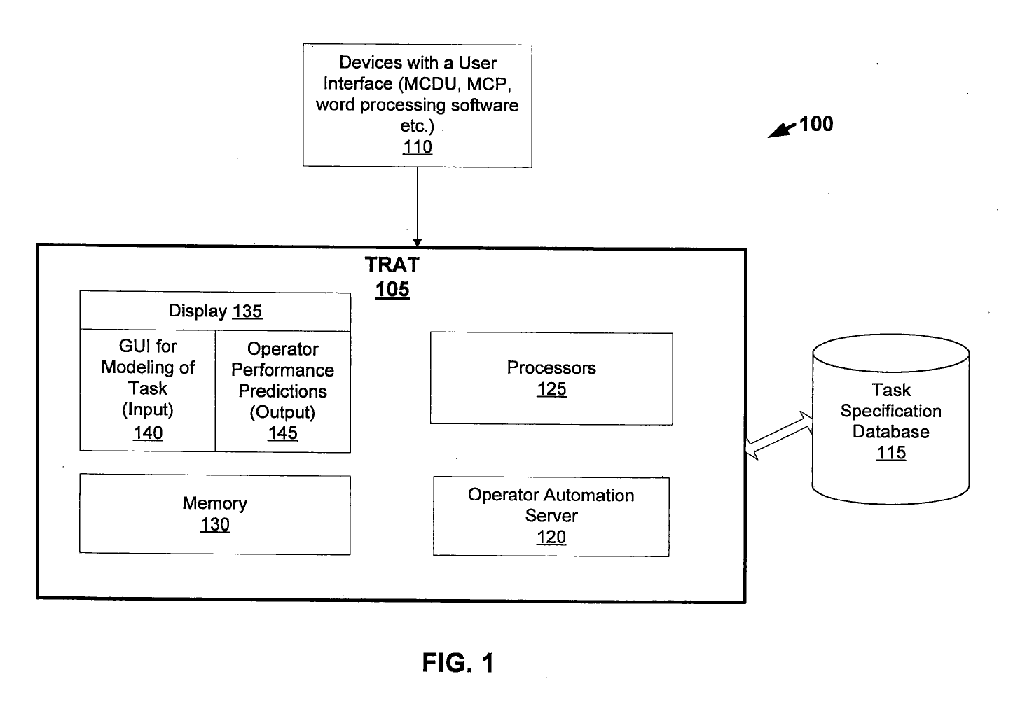

Referring to FIG. 1 where the present invention can be embodied in the evaluation and prediction system 100, system 100 can comprise a Task Reliability Analysis Tool (TRAT) 105 and a task specification database 115.

System 100 can evaluate and predict the reliability of any device 110 with a user interface, such as an enterprise automation interface, including but not limited to, a Multi-Function Control and Display Unit (MCDU) or a Model Control Panel (MCP) from a commercial airliner, a web page, a user interface of word processing software or document creation program or the like. For example, MCDU can be a component of a Flight Management System (FMS) which can be a specialized computer system that automates a wide variety of in-flight mission tasks. In one embodiment, mission tasks associated with user interaction with device 100 can be collected and provided to TRAT 105 for further analysis.

According to one embodiment of the invention, TRAT 105 can comprise an operator automation server 120, processors 125, a memory 130 and a display 135. Display 135 can provide both an input interface 140 which serves as a Graphic User Interface (GUI) for modeling the task and an output interface 145 to display operator performance analysis and predictions. Based on the input selected by the design engineer via input interface 140 and raw data collected from device 110, operator automation server 120, utilizing memory 130 and processors 125, can analyze and predict the performance of a mission task. Thus, the performance reports can be displayed on output interface 145 and stored in database 115.

In one embodiment, task specification database 115 can store raw data pertaining to a mission task such as frequency of occurrence and impact of non-compliance. In another embodiment, TRAT 105 can manipulate the raw data to generate new metrics associated with task definition, operator action definition and task specification, and in turn store the new metrics into database 115. In another embodiment, TRAT 105 can retrieve data from database 115 and process the data linked with a mission task to generate evaluation and prediction report on the task performance and efficiency, which can be further stored indefinitely in database 115.

In another embodiment, the processes for embodiments of the present invention can be performed by operator automation server 120 using computer usable program codes, which may be located in a memory such as memory 130 or read only memory, or as an alternative, in one or more peripheral devices.

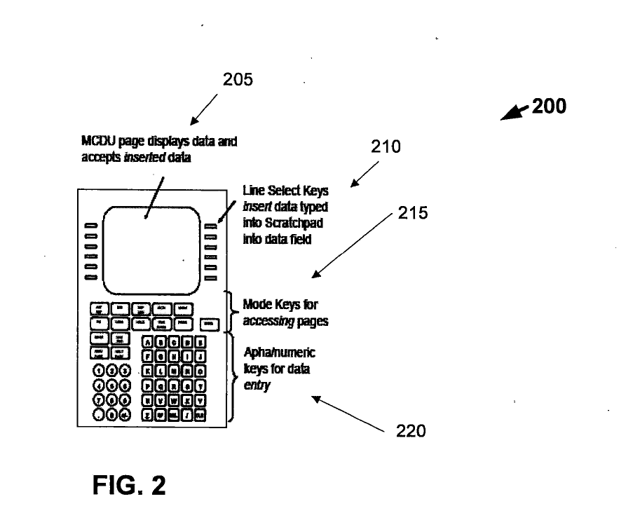

FIG. 2 illustrates a user interface of the Multi-Function Control and Display Unit (MCDU), which serves as an example of the devices that can be evaluated and predicted by the TRAT. A human operator can utilize MCDU 200 to interact with an automation system on the flightdeck of a commercial airliner, according to one embodiment. In this embodiment, MCDU 200 can include a MCDU display 205 to accept data input and display data; a set of line select keys (LSK) 210 to insert input data from a scratchpad; mode keys 215 for accessing different pages; and alpha/numeric keys 220 for data entry.

The MCDU display 205 is partitioned into 12 regions, with one region for each of the six right and six left line select keys (LSKs) 210, enabling the human operators to select the data associated with the LSKs 210. Mode keys 215, such as INIT-REF, RTE, LEG, can display series of pages associated with that key. Each mode key 215 can be described in terms of function of the page or series of pages accessed by that key. Furthermore, pressing an alpha or numeric key can enter the corresponding character or number into the scratchpad.

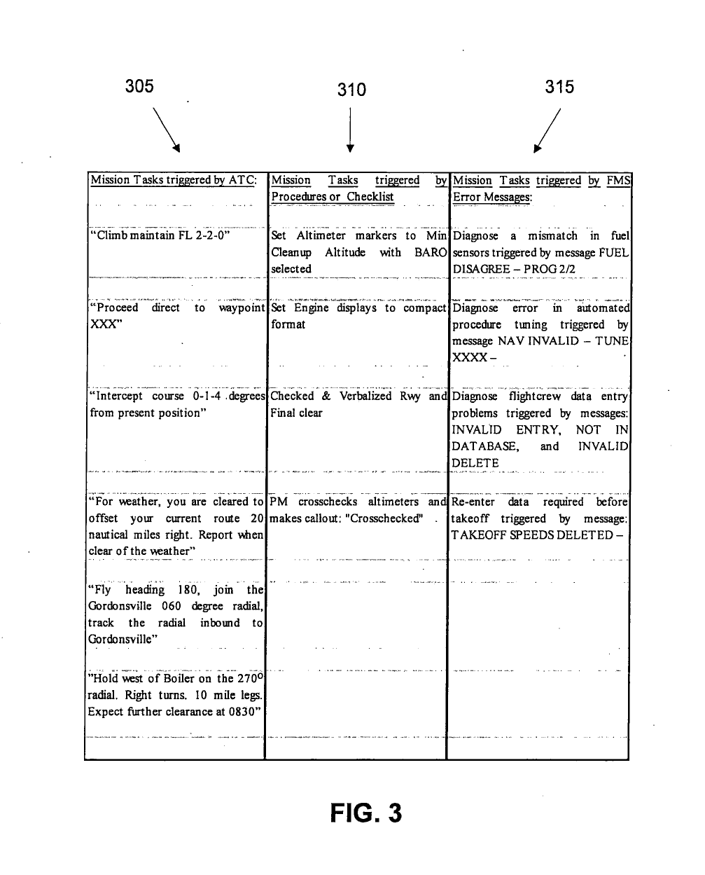

FIG. 3 depicts a sample of mission tasks for a commercial airliner, according to one embodiment. In this example, interactions can occur between a human operator and the automation on the flightdeck of a commercial airliner to complete mission tasks. Mission tasks can be triggered by Air traffic Control (ATC) instructions 305, procedures or checklist 310, or Flight Management System (FMS) error messages 315.

For example, the mission task can be triggered by ATC at 305, such as “proceed directly to waypoint XXX.” Alternatively, the mission task can be triggered by procedures or checklist at 310 such as “set engine display to compact format.” In another example, the task can be triggered by FMS error messages at 315 such as “diagnose a mismatch in fuel sensor triggered by message FUEL DISAGREE—PROG 2/2.”

Airlines can usually provide detailed instructions on how to respond to the above referenced triggered scenarios in the form of standard operating procedures which embed the rules and regulations of the Federal Aviation Regulations (FAR) and Aeronautical Information Manual (AIM). The mission tasks, initiated by voice communication, aural alerting, visual cues, or prospective memory, can be performed using flightdeck automation such as the Flight Control Computer and its Mode Control Panel (MCP) or a Multi-Function Control and Display Unit (MCDU) located on a Flight Management System (FMS).

When a task is triggered, the flightcrew can identify the task and the task specific parameters, and subsequently determine which function of the automation to use. For example, to execute the ATC instruction to perform a Hold at a waypoint, the flightcrew can use the FMS—LNAV Hold function which can be explicitly designed to automate the task of flying holding patterns with an accuracy that cannot be achieved flying manually. Particularly, the mission task can be accomplished using the MCP at the presence of a crosswind. In addition, mental math can be used to convert parameters from the ATC instruction to relevant data that can be entered into the automation.

After deciding which function to use, the flightcrew may access the corresponding function. In the event that the operator uses a MCDU, the process may involve several button-pushes to locate the correct display page. Subsequently, the flightcrew may enter the appropriate data or make the appropriate selections. In fact, the entry/selection may be cross-checked with the other pilot and executed by an additional operator action such as pushing the EXECute key on the MCDU. Indeed, for mission tasks, especially those associated with following the flightplan, the airplane trajectory may be monitored closely.

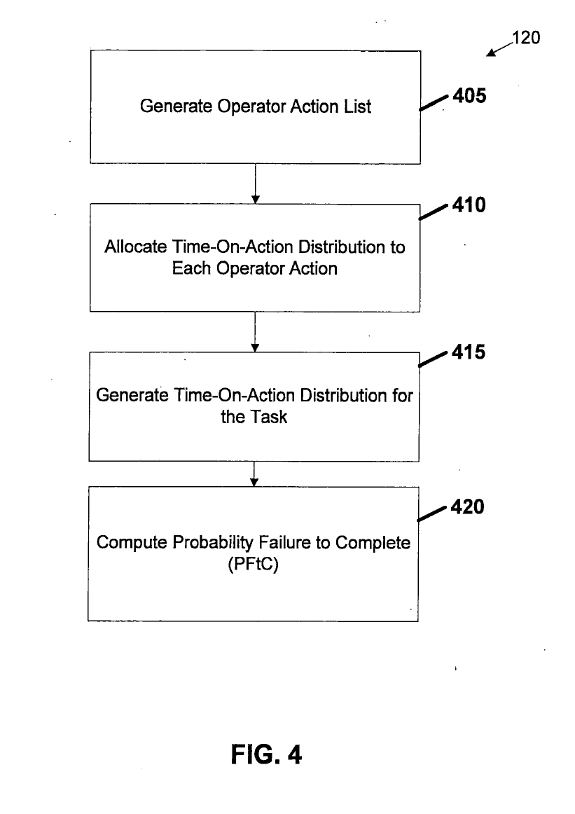

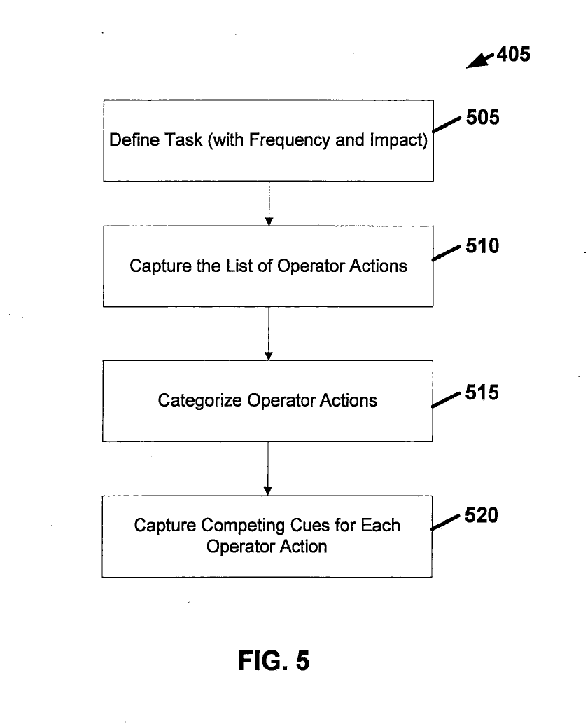

FIG. 4 illustrates a method employed by the operator automation server 120 to evaluate and predict reliability of human computer interactions for achieving a mission task, according to one embodiment of the present invention. Operator automation server 120 can initiate the evaluation and prediction process by generating an operator action list pursuant to a mission task at 405, which will be discussed in detail in FIG. 5. Server 120 can proceed with allocating a time-on-action distribution to each operator action at 410, generating a time-on-action distribution for the mission task at 415 and computing a Probability Failure to Complete (PFtC) at 420.

FIG. 5 illustrates how operator automation server 120 can generate an operator action list, according to one embodiment. In the process of generating an operator action list referred at 405, the operator automation server 120 can define the task at 505, capture the list of operator actions at 510, categorize the operator actions at 515, and capture competing cues for each operator action at 520.

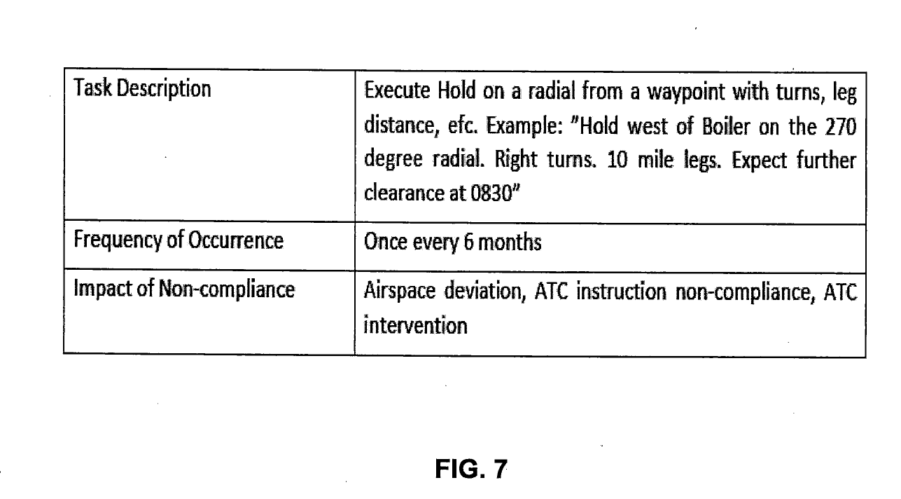

In defining the mission task at 505, certain metrics such as frequency of occurrence and impact of non-compliance can be assigned to the mission task. FIG. 7 is an example of a definition of a mission task, according to one embodiment. In this example, a task pertaining to “Execute hold on a radial from a waypoint with turns, leg distance, efc.” is described as “Hold west of Boiler on the 270 degree radial. Right turns. 10 mile legs. Expect further clearance at 0830.” Furthermore, additional metrics such as the frequency of occurrence can be defined as “once every 6 months,” while the impact of non-compliance can be defined as “airspace deviation, ATC instruction non-compliance and ATC intervention.”

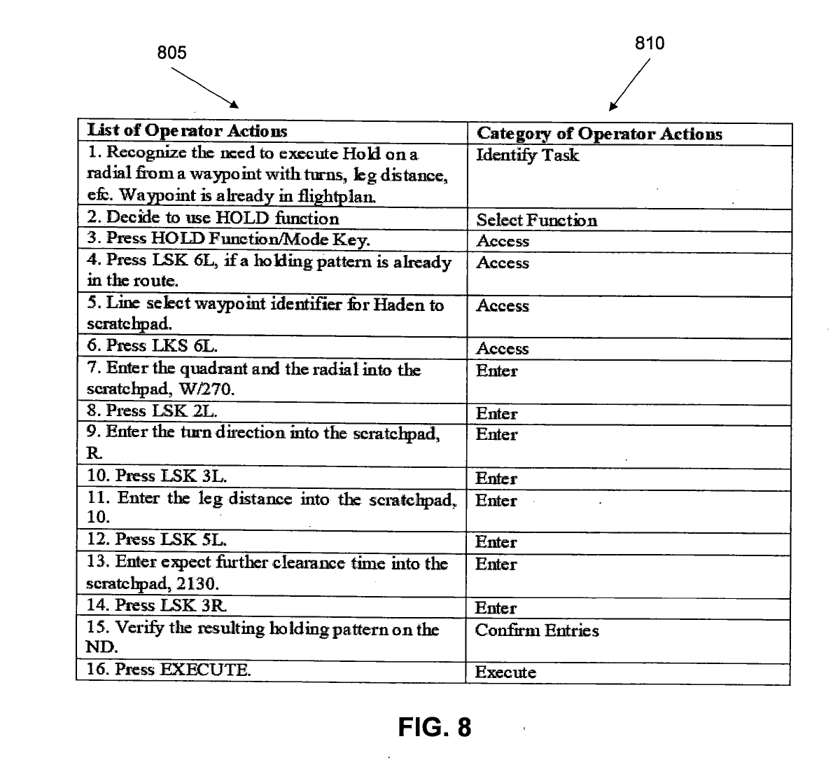

After the task is properly defined at 505, a list of the operator actions related to the mission task can be captured in the process at 510. FIG. 8 displays a list of operator actions captured by operator automation server 120 at column 805 in one embodiment. For example, based on the definition obtained at 505, the list can comprise “recognize the need to execute hold on a radial from a waypoint in turns, leg distance, efc.,” “decide to use hold key,” and “press hold function key” etc. In summary, to accomplish the task displayed at column 805, 16 operation actions need to be performed.

The first operator action of any task can be “identification of the task,” which is defined as “recognize the need to <task description goes here>.” The second operator action on the list for any task can be “decide to use the <function name goes here>.” These two operator actions can be decision-making operator actions. In contrast, the rest of the operator actions can be generally physical actions such as to access the correct display, enter data, confirm entries, and execute the instructions.

After the list of operator actions can be captured at 510, operator automation server 120 can proceed to categorize the operator actions at 515. FIG. 8 is an example on how the operator actions may be categorized, according to one embodiment, with column 810 illustrating the categories of operation actions. Indeed, the operator actions can be sorted into the following six distinct operator categories according to the definitions and characteristics of the operator actions:

(1) Identify Task: this is a decision-making category to recognize the need to perform a task. In some embodiments, this category of operator actions may be the result of a visual or aural cue from the environment such as from a coworker's instructions, a predefined checklist, or an error message. Alternatively, it may be the result of a decision-making or memory invoked to perform a task at a specific time.

(2) Select Function: this can also recite a decision-making category to determine which feature or function of the automation may be used, referred to as mapping the task to the function.

(3) Access Function: this can be a physical action to display the correct window, wizard, and etc.

(4) Enter data Function: this is a physical action to enter data or select the relevant options.

(5) Confirm and Execute Data: this can encompass a physical action to verify the correct entry of data or selections and subsequently to save or confirm the operators' intentions.

(6) Monitor Function: this can generally refer to monitor the automation to ensure that it can perform the desired task in the preferred manner.

Based on the classification system mentioned above, the 15 operator actions on the list captured at 510 can be categorized into 6 categories of operator actions as displayed at 810 in FIG. 8.

Returning to FIG. 5, operator automation server 120 can proceed to capture the competing cues for each operator action at 520. When human operators perform infrequent tasks, they can rely on cues in the user-interface to guide their actions. Visual cues such as labels, prompts, or graphical icons, provide the most common type of operator guidance. Because human operators do not perform exhaustive searches and select the optimal operator actions, they can instead pick what seems to be the best option in the first few micro-seconds of scanning the user-interface. Indeed, the likelihood that the correct cue will be used to guide the next operator action can dependent on 1) whether it is located in the area of the user-interface that captures the operator's attention; and 2) whether there are visual cues with semantic similarities to the task that can confuse the operator. Accordingly, the competing cues are the visual cues with semantic similarities or physical proximities to the operator actions to be performed in the mission task, which distract the human operator from performing the correct operator actions. Given that competing cues serve as false triggers for an action to be carried out at a specific time, they incur penalties and interfere with the proper operator actions of the mission task. For example, a button labeled as “hold” has high semantic similarity with the task “hold at present position.” Thus, it is a competing cue for the mission task “hold at the present position,” even though the “hold” button may have nothing to do with the task “hold at present position.”

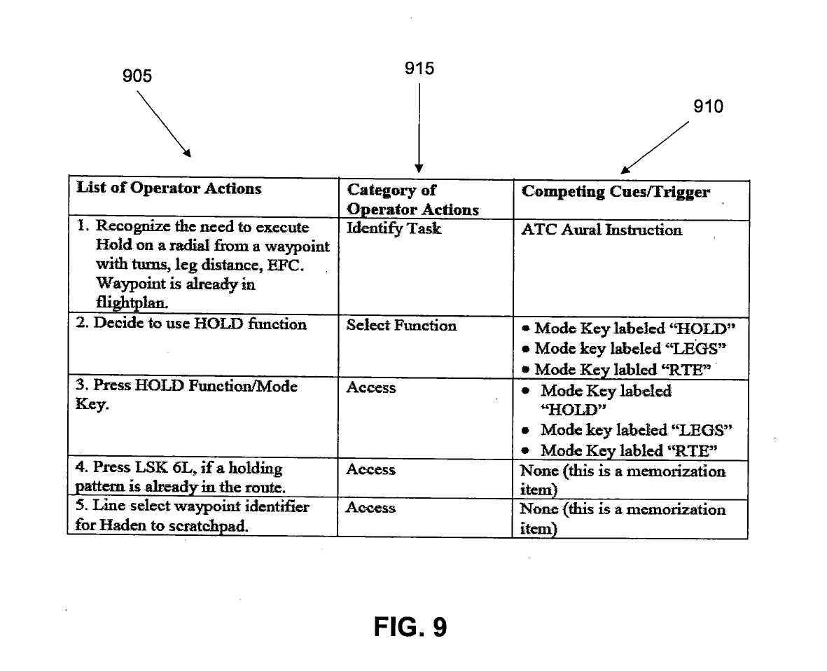

FIG. 9 illustrates the competing cues for a list of operator actions, according to one embodiment, as indicated at 910. For example, for the operator action “decide to use hold function” at column 905 of the operator action list, the competing cues can be mode key labeled “hold,” mode key labeled “legs,” and mode key labeled “RTE,” as displayed at 910, due to their semantic similarity and physical proximity. It is worth noting that the reliability of performance of operator actions can be dependent on the presence of salient visual cues to guide the user. Accordingly, when a user interface lacks clear labels, prompts, or organizational structure, there can be a higher probability that the operator will suffer memory errors.

The memory errors can fall in two categories: unsuccessful information retrieval from memory (referred to as retrospective memory errors), and forgetting of intentions (referred to as prospective memory failures). The prospective memory failures can differ from the retrospective failures in that the failures of the memory retrieval occur at remembering to perform a planned action or intention at the appropriate time such as forgetting to send an email. Conversely, the retrospective memory errors can occur when the attempt to retrieve information is unsuccessfully such as forgetting where to change a password. Problems on prospective memory can be attributable to the mechanisms by which retrieval is initiated via cueing and attention, because the presence of cues and prompts can initiate the retrieval of intentions. Consequently, a good reminder cue can have a clear association to the specific intention and a high probability of calling that intention to mind, where the cue can be salient, or highly noticeable at the time that the intention is to be performed.

Given that the operator actions in the list can be the individual decision making actions and physical actions to be performed to complete the mission task, operator automation server 120 can examine and process each item in the operation action list. In particular, if there exists one or more competing cues for the operation action, operator automation server 120 can insert an additional operator action proximate the current action under inspection and label the competing cue as the same type as the current action, until the operator action list is exhausted.

Referring back to FIG. 4, where operator automation server 120 has generated an operator action list at 405, sever 120 can proceed to allocate a time-on-action distribution to the operator actions at 410. Because the operator actions contained in the list have been categorized at 405 at this point and each category can be performed by one or more operator actions, a time-on-action distribution can be allocated based on the categories. For example, for all operator actions falling into the category “Identify the Task,” the same Gamma distribution can be allocated. In turn, for all operator actions falling into the category “Select Function,” the same Gamma distribution can be allocated. For all operator actions falling into the category “Access,” the same Gamma distribution can be allocated. For all operator actions falling into the category “Enter,” the same Gamma distribution can be allocated, depending on number of buttons the human operator has to push in order to enter the instructions. For all operator actions falling into the category “Confirm and Execute,” the same Gamma distribution can be allocated. Accordingly, for all operator actions falling into the category “Monitor,” the same Gamma distribution can be allocated. In another embodiment, the distribution allocated to each operator action category may correspond to Random/Gaussian distribution, or any other appropriate distribution.

Although the operator action can be abstracted into categories, with a distribution allocated on each category of the operator actions, the distribution can be allocated to the individual operator actions directly, without reference to their categories.

Furthermore, based on the distribution allocated to each operator action at 410, operator automation server 120 can generate a time-on-action distribution for the entire mission task at 415. In one embodiment, closed form equations can be used to generate a histogram for the entire mission task. In another embodiment, Monte Carlo simulation can be used on the Gamma distributions for each operator action, and generate a histogram for the entire mission task.

Finally, according to the histogram obtained in the previous calculation at 415 and the Maximal Allowable Time (MAT) stipulated by the design engineer, Probability Failure to Complete (PFtC) and time on task distribution can be calculated to indicate the proficiency of a mission task at 420. MAT can be a predefined parameter associated with the mission task or a value selected by the design engineer based on his or her experience evaluating and estimating similar tasks. Task proficiency, defined as the ability to complete a task within the allowable time window such as indicated by MAT, can measure and predict the reliability and performance of a given mission task.

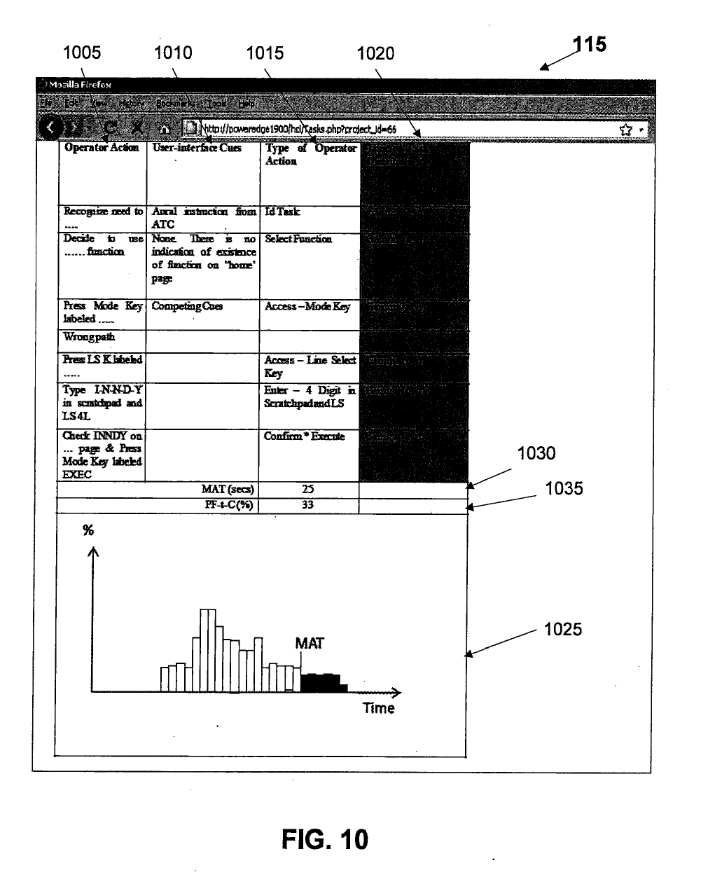

A typical distribution for time-on-task for a given task is shown at 1025 of FIG. 10, which can exhibit a long right tail. The subjects that are able to complete the task within the allowable time window can be considered as proficient, while the subjects that are unable to complete the task within the allowable time window can be considered to be not proficient as indicated by the shaded area in FIG. 10. Consequently, in aggregation, the tail of the distribution in excess of the allowable time window can define the Probability Failure-to-Complete (PFtC) for the mission task.

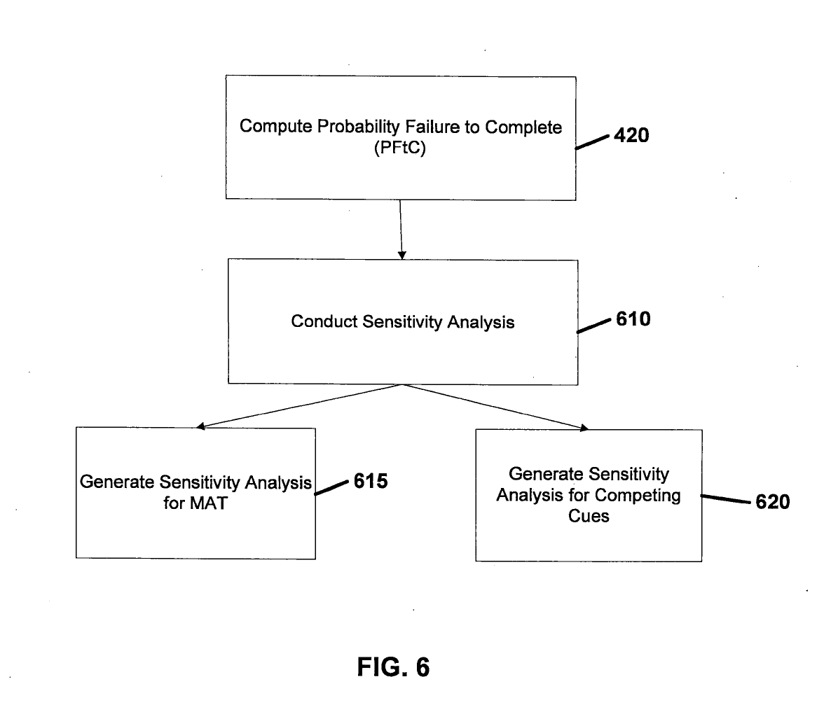

FIG. 6 illustrates a method that the operator automation server 120 employs to conduct a sensitivity analysis, according to one embodiment. After completing the computation of Probability Failure to Complete (PFtC) as indicated at 420, operator automation server 120 can conduct a sensitivity analysis at 610 based on the value of PFtC obtained at 420.

In some embodiments, operator automation server 120 can generate a sensitivity analysis based on MAT at 615. For example, operator automation server 120 can loop through 2% increments of MAT and compute PFtC, from a range of MAT−20% to MAT+20%.

In other embodiments, operator automation server 120 can further generate a sensitivity analysis based on competing cues at 620. For example, operator automation server 120 can incrementally eliminate competing cues on the operator action list and generate PFtC.

FIG. 10 depicts an example of a graphic user interface of the mission task analysis, according to one embodiment. In this embodiment, a design engineer enters the data for the operator actions at 1005, which corresponds to processes defining a task at 505 and capturing the list of operator actions at 510 in FIG. 5. The operator action categories are listed at 1015, corresponding to process of categorizing operator actions at 515, while the user interface cues and competing cues are listed at 1010, corresponding to the process of capturing competing cues for each operator action at 520.

The time on task distribution is obtained at 1020 consistent with the process of allocating time-on-action to each operator action at 410 in FIG. 4. Furthermore, the time-on-action distribution for the task is displayed at 1025, consistent with the process of generating time-on-action distribution for the task at 415. Finally, the MAT is specified at 1030 by the design engineer and PFtC is calculated at 1035, which correspond to the process of computing PFtC at 420. Therefore, to accomplish the analysis for the mission task, FIG. 10 illustrates all the relevant processes discussed in FIG. 4.

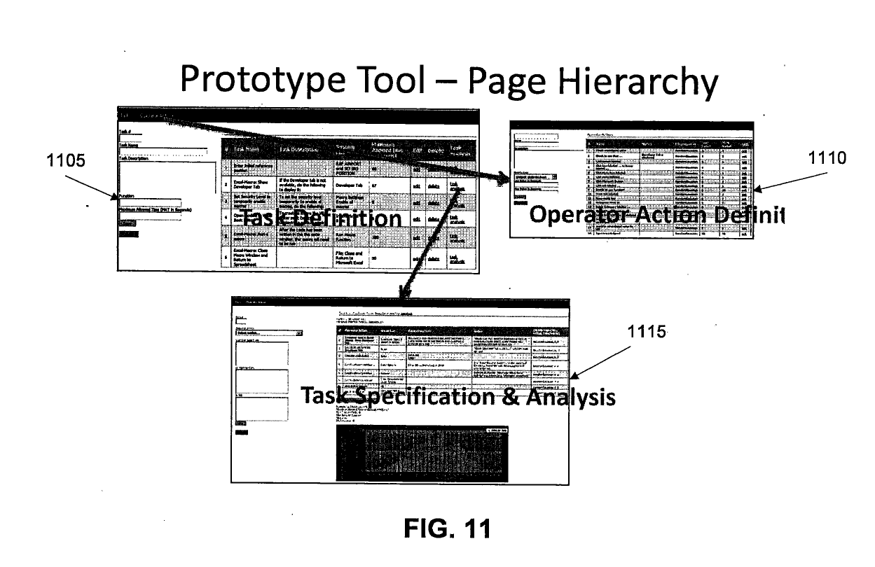

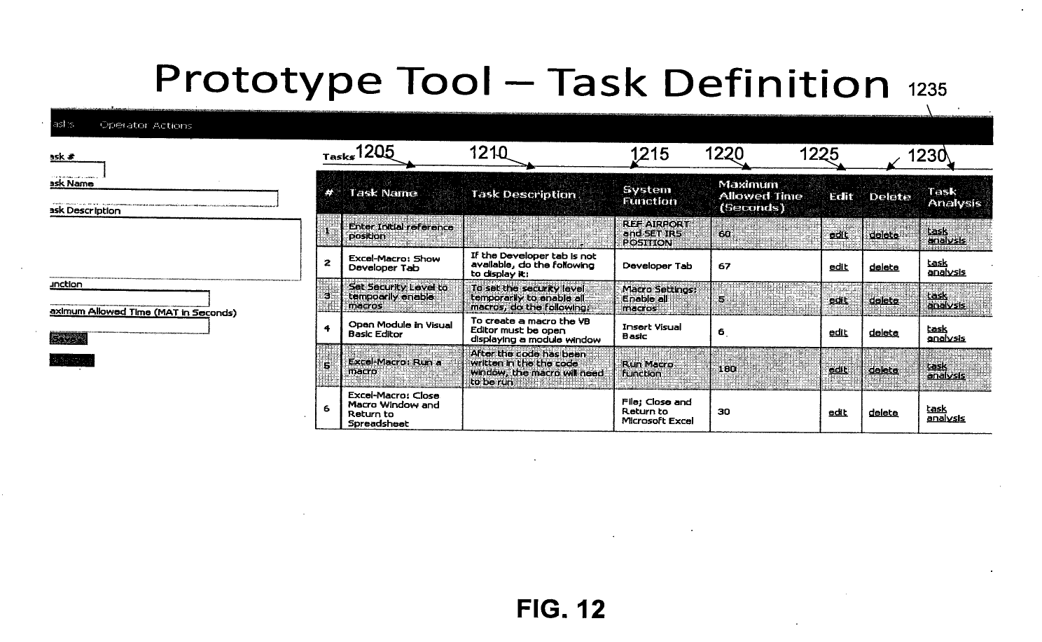

FIG. 11 illustrates the page hierarchy of the graphic user interface of the TRAT, according to one embodiment. In this embodiment, the interface can comprise a task definition page 1105, an operator action definition page 1110, and a task specification and analysis page 1115, which will be illustrated in FIGS. 12, 13 and 14 respectively. The “operator action” tab on the task definition page 1105 can provide a link to the operator action definition page 1110. Similarly, clicking “task analysis” on the task definition page 1105 can link to the task specification and analysis page 1115.

FIG. 12 illustrates an example of a graphic user interface for the mission task definition page of the TRAT, according to one embodiment, corresponding to the process of defining the task at 505 in FIG. 5. In this embodiment, the task definition page can include columns containing task name 1205, task description 1210, system function 1215, MAT 1220, edit tab 1225, delete tab 1230, and task analysis 1235; which can display and record numerous parameters associated specifically with that mission task.

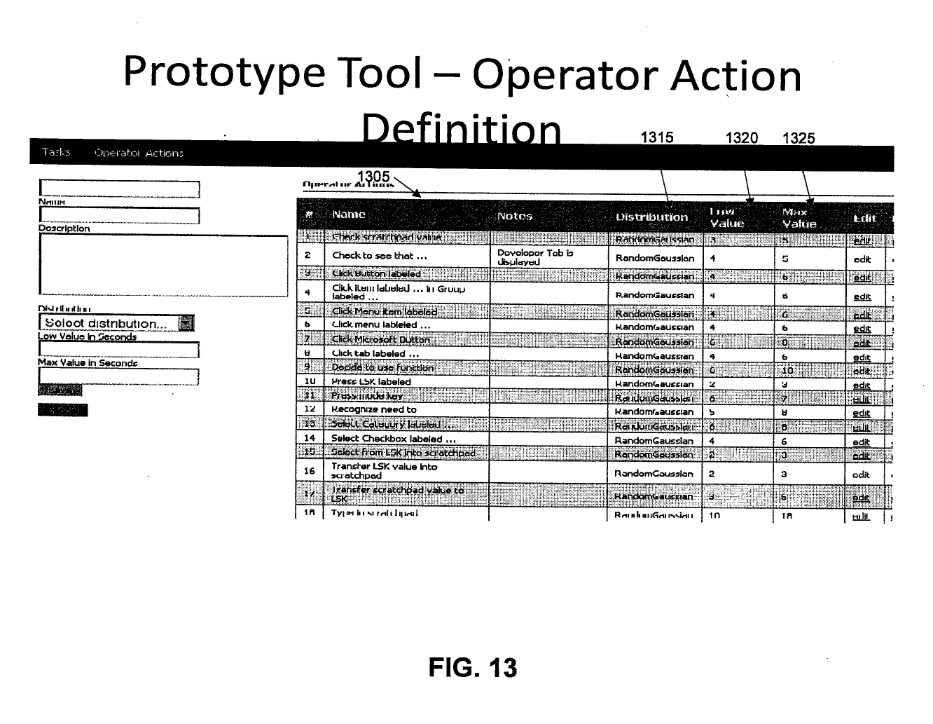

FIG. 13 illustrates an example of a graphic user interface for the operator action definition page of the TRAT, according to one embodiment, which corresponds to the process of generating the operation action list at 405 and the allocating the time-on-action distribution to each of the operator action at 410 in FIG. 4. In the operator action definition page, the parameters associated with each operator action can be displayed and recorded, such as operator action name 1305, distribution 1315, minimal value 1320 and maximal value 1325 of the distribution for the operator actions.

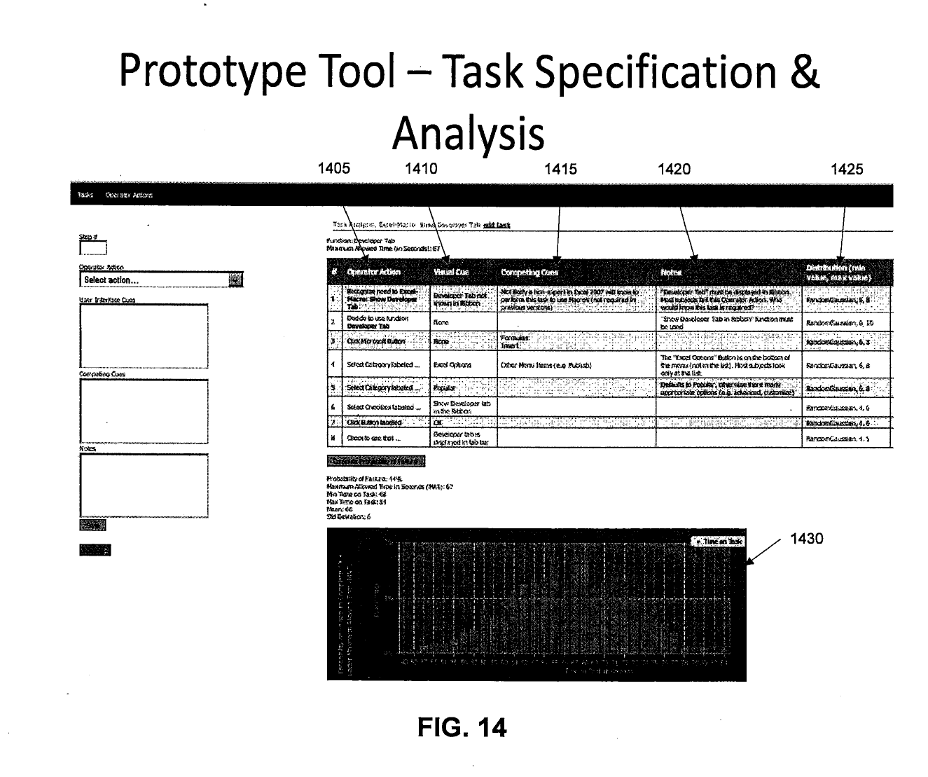

FIG. 14 illustrates an example of a graphic user interface for the mission task specification and analysis page of the TRAT, similar to FIG. 10. Indeed, the graphic user interface for the mission task specification and analysis page can perform numerous functions as illustrated in the previous figures, such as allocating of the time-on-action distribution of the task at 415, computing of the Failure to Complete 420 in FIG. 4, generating of the sensitivity analysis for MAT at 615 and generating of the sensitivity analysis for the competing cues at 620 in FIG. 6. In this example, a Random/Gaussian distribution is allocated to the operator actions in lieu of Gamma distribution utilized in FIG. 10.

Based on the data gathered from the task specification and analysis page in FIG. 14, in one embodiment of the present invention, TRAT can provide feedback for correcting actions and error recovery. In another embodiment, TRAT can provide guidance on the execution of a novel or an infrequently performed procedure. In another embodiment, TRAT can improve the attributes of usability in an automated system including ease of learning and use. In another embodiment, TRAT can be used to predict repetitions required to master a mission task.

It should be understood that various changes and modifications to the presently preferred embodiments described herein will be apparent to those skilled in the art. Such changes and modifications may be made without departing from the spirit and scope of the present invention and without diminishing its attendant advantages.

The following references are included to provide background information as an aid to explain the present embodiments:

In this specification, “a” and “an” and similar phrases are to be interpreted as “at least one” and “one or more.”

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described examples of the embodiments.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A computer-implemented method for determining the reliability of human-computer interactions for achieving a mission task in an automated system comprising:
generating, using a computing system including one or more processors, an operator action list of the mission task;
obtaining, with the computing system, a time-on-action distribution to each operator action in the mission task;
determining, using the computing system, a time-on-action distribution to the mission task based on the time-on-action distribution of each operator action in the mission task; and
determining, using the computing system, a Probability-Failure-to-Complete (PFtC) of the mission task.

2. The method of claim 1, further comprising:
generating, using the computing system, a sensitivity analysis for Maximal Allowed Time (MAT) of the mission task.

3. The method of claim 1, wherein the generating of the operator action list includes capturing competing cues associated with each operator action.

4. The method of claim 3, wherein the obtaining of the time-on-action distribution to each operator action includes allocating the time-on-action distribution penalty for the competing cues associated with each operator action.

5. The method of claim 4, wherein the determining of the time-on-action distribution to the mission task includes allocating the time-on-action distribution of the mission task based on the competing cues.

6. The method of claim 5, further comprising:
generating, using the computing system, a sensitivity analysis for the competing cues associated with the mission task.

7. The method of claim 1, wherein the obtained time-on-action distribution to at least one operator action corresponds to a Gamma distribution.

8. The method of claim 1, wherein the obtained time-on-action distribution to at least one operator action corresponds to a Random Gaussian distribution.

9. The method of claim 1, wherein the determining of the time-on-action distribution to the mission task includes using closed-form equations.

10. The method of claim 1, wherein the determining of the time-on-action distribution to the mission task includes using Monte Carlo simulation.

11. A system to determine the reliability of human-computer interactions for achieving a mission task in an automated system comprising:
at least one data base storing specification data related to the mission task; and
a computing system including at least one processor configured to:
generate an operator action list of the mission task;
obtain a time-on-action distribution to each operator action in the mission task;
determine a time-on-action distribution to the mission task based on the time-on-action distribution of each operator action in the mission task; and
determine a Probability-Failure-to-Complete (PFtC) of the mission task.

12. The system of claim 11, wherein the computing system is further configured to:
generate a sensitivity analysis for Maximal Allowed Time (MAT) of the mission task.

13. The system of claim 11, wherein the generating of the operator action list includes capturing competing cues associated with each operator action.

14. The system of claim 13, wherein the obtaining of the time-on-action distribution to each operator action includes allocating the time-on-action distribution penalty for the competing cues associated with each operator action.

15. The system of claim 14, wherein the determining of the time-on-action distribution to the mission task includes allocating the time-on-action distribution of the mission task based on the competing cues.

16. The system of claim 15, wherein the computing system is further configured to:
generate a sensitivity analysis for the competing cues associated with the mission task.

17. The system of claim 11, wherein the obtained time-on-action distribution to at least one operator action corresponds to a Gamma distribution.

18. The system of claim 11, wherein the obtained time-on-action distribution to at least one operator action corresponds to a Random Gaussian distribution.

19. The system of claim 11, wherein the determining of the time-on-action distribution to the mission task includes using closed-form equations.

20. The system of claim 11, wherein the determining of the time-on-action distribution to the mission task includes using Monte Carlo simulation.
